(19) United States
(12) Patent Application Publication
(10) Pub. No.: US 2005/0089789 A1
(43) Pub. Date: Apr. 28, 2005

(54) Organophotoreceptor with a light stabilizer

(75) Inventor: Jiayi Zhu, Woodbury, MN (US)

Correspondence Address: Patterson, Thuente, Skaar & Christensen, P.A., 4800 IDS Center, 80 South 8th Street, Minneapolis, MN, 55402-2100, US

(73) Assignee: Samsung Electronics Co., Ltd.

(21) Appl. No.: 10/982,564

(22) Filed: Nov. 5, 2004

Related U.S. Application Data
(62) Division of application No. 10/425,333, filed on Apr. 28, 2003.
(60) Provisional application No. 60/385,233, filed on May 31, 2002.

(51) Int. Cl. G03G 15/14

(52) U.S. Cl. 430/126

(57) ABSTRACT

This invention relates to an improved organophotoreceptor that includes an electrically conductive substrate having a surface and a photoconductive element on said surface of said electrically conductive substrate. The photoconductive element comprises a layer with a polymeric binder, an electron transport compound, and a light stabilizer. The layer can also comprise a charge generating compound and/or a charge transport compound.

### CROSS REFERENCE TO RELATED APPLICATIONS

This application is a divisional application of copending U.S. patent application Ser. No. 10/425,333, filed on Apr. 28, 2003, now U.S. Pat. No. ______, which claims priority to copending U.S. provisional patent application Ser. No. 60/385,233 to Zhu filed on May 31, 2002, entitled “Organophotoreceptor With A Light Stabilizer,”incorporated herein by reference.

### FIELD OF THE INVENTION

This invention relates to organophotoreceptors suitable for use in electrophotography and, more specifically, to organophotoreceptors having a light stabilizer, a charge generating compound, a charge transport compound, and an electron transport compound in one or more layers.

### BACKGROUND OF THE INVENTION

In electrophotography, an organophotoreceptor in the form of a plate, disk, sheet, belt, drum or the like having an electrically insulating photoconductive element on an electrically conductive substrate is imaged by first uniformly electrostatically charging the surface of the photoconductive element, and then exposing the charged surface to a pattern of light. The light exposure selectively dissipates the charge in the illuminated areas, thereby forming a pattern of charged and uncharged areas. A liquid or solid toner is then deposited in either the charged or uncharged areas depending on the properties of the toner to create a toned image on the surface of the photoconductive element. The resulting toned image can be transferred to a suitable receiving surface such as paper. The imaging process can be repeated many times to complete a single image and/or to reproduce additional images.

Both single layer and multilayer photoconductive elements have been used. In the single layer embodiment, charge generating compound and a charge transport material selected from the group consisting of a charge transport compound, an electron transport compound, and a combination of both are combined with a polymeric binder and then deposited on the electrically conductive substrate. In the multilayer embodiments based on a charge transport compound, the charge transport compound and charge generating compound are in the form of separate layers, each of which can optionally be combined with a polymeric binder, deposited on the electrically conductive substrate. Two arrangements are possible. In one arrangement (the “dual layer” arrangement), the charge generating layer is deposited on the electrically conductive substrate and the charge transport layer is deposited on top of the charge generating layer. In an alternate arrangement (the “inverted dual layer” arrangement), the order of the charge transport layer and charge generating layer is reversed.

In both the single and multilayer photoconductive elements, the purpose of the charge generating material is to generate charge carriers (i.e., holes and/or electrons) upon exposure to light. The purpose of the charge transport material is to accept these charge carriers and transport them through the charge transport layer in order to discharge a surface charge on the photoconductive element. When a charge transport compound is used, the charge transport compound accepts the hole carriers and transports them through the layer in which the charge transport compound is located. When an electron transport compound is used, the electron transport compound accepts the electron carriers and transports them through the layer in which the electron transport compound is located.

### SUMMARY OF THE INVENTION

In a first aspect, the invention features an organophotoreceptor that includes an organophotoreceptor comprising an electrically conductive substrate having a surface and a photoconductive element on said surface of said electrically conductive substrate wherein said photoconductive element comprises a first layer comprising a polymeric binder, an electron transport compound and a UV light stabilizer. In some embodiments, the first layer further comprises a charge generating compound and/or a charge transport compound.

In a second aspect, the invention features an electrophotographic imaging apparatus that includes (a) a light imaging component; and (b) the above-described organophotoreceptor oriented to receive light from the light imaging component. The organophotoreceptor can be, for example, in the form of a drum or in the form of a flexible belt threaded around support rollers. The apparatus can further comprise a toner dispenser.

In a third aspect, the invention features an electrophotographic imaging process that includes (a) applying an electrical charge to a surface of the above-described organophotoreceptor; (b) imagewise exposing the surface of the organophotoreceptor to radiation to dissipate charge in selected areas and thereby form a pattern of charged and uncharged areas on the surface; (c) contacting the surface with a toner to create a toned image; and (d) transferring the toned image to a substrate.

### BRIEF DESCRIPTION OF THE DRAWINGS

FIG. 1 is a schematic side view of an organophotoreceptor with a photoconductive layer on an electrically conductive substrate.

FIG. 2 is a schematic side view of an organophotoreceptor with a charge generating layer and a charge transport layer sequentially on an electrically conductive substrate.

FIG. 3 is a schematic side view of an organophotoreceptor with a charge transport layer and a charge generating layer sequentially on an electrically conductive substrate.

FIG. 4 is a schematic side view of an organophotoreceptor with a charge transport layer, a charge generating layer and an electron transport layer sequentially on an electrically conductive substrate.

FIG. 5 is a schematic side view of an organophotoreceptor with an electron transport layer, a charge generating layer and a charge transport layer sequentially on an electrically conductive substrate.

### DETAILED DESCRIPTION OF PREFERRED EMBODIMENTS

Improved organophotoreceptor comprise an electron transport compound and an ultraviolet light stabilizer within at least one layer of the structure. The layer with the electron transport compound and the UV light stabilizer can also comprise a polymeric binder, a charge transport compound, and/or a charge generating compound. In general, the organophotoreceptor comprises an electrically conductive substrate having a photoconductive element on a surface of the electrically conductive substrate in which the photoconductive element can include one or more layers, i.e., sublayers, within its structure. One or more of the layers of the photoconductor may include an electron transport compound and a UV light stabilizer. The electron transport compound and the UV light stabilizer have a synergistic relationship for providing desired electron flow within the photoconductor.

With the combination of the light stabilizer and the electron transport compound, the organophotoreceptor has a high V_{acc}, a low V_{dis}, and high stabilities with respect to cycling testing, crystallization, bending and stretching. The organophotoreceptors are particularly useful in laser printers and the like as well as photocopiers, scanners and other electronic devices based on electrophotography. The use of these organophotoreceptors is described in more detail below in the context of laser printer use, although their application in other devices operating by electrophotography can be generalized from the discussion below.

To produce high quality images, particularly after multiple cycles, it is desirable for the compounds of the organophotoreceptor to form a homogeneous solution with the polymeric binder and remain approximately homogeneously distributed through the organophotoreceptor material during the cycling of the material. In addition, it is desirable to increase the amount of charge that the organophotoreceptor can accept (indicated by a parameter known as the acceptance voltage or “V_{acc}”), and to reduce retention of that charge upon discharge (indicated by a parameter known as the discharge voltage or “V_{dis}”).

Electron transport compounds have an appropriate ability to transport electrons, in contrast with charge transport compounds, which are generally more effective at transporting holes, i.e., positive charges. The presence of the UV light stabilizers alters the electron transport properties of the electron transport compounds to improve the electron transporting properties of the composite. UV light stabilizers can be ultraviolet light absorbers or ultraviolet light inhibitors that trap free radicals.

In electrophotography applications, a charge generating compound within an organophotoreceptor absorbs light to form electron-hole pairs. These electron-hole pairs can be transported over an appropriate time frame under a large electric field to discharge locally a surface charge that is generating the field. The discharge of the field at a particular location results in a surface charge pattern that essentially matches the pattern drawn with the light. This charge pattern then can be used to guide toner deposition. To print a two dimensional image using the organophotoreceptor, the organophotoreceptor has a two dimensional surface for forming at least a portion of the image. The imaging process then continues by cycling the organophotoreceptor to complete the formation of the entire image and/or for the processing of subsequent images.

The organophotoreceptor may be provided in the form of a plate, a flexible belt, a disk, a rigid drum, a sheet around a rigid or compliant drum, or the like. The charge transport compound and/or the electron transport compound can be in the same layer as the charge generating compound and/or in a different layer from the charge generating compound. For example, the electron transport compound may be in an overcoat layer. In some embodiments, the organophotoreceptor material has a single layer with both a charge transport composition and a charge generating compound within a polymeric binder. In further embodiments, a charge generating compound is in a charge transport layer distinct from the charge generating layer. For embodiments with the improved overcoats described herein, the charge transport layer generally is intermediate between the charge generating layer and the electrically conductive substrate. Alternatively, the charge generating layer may be intermediate between the charge transport layer and the electrically conductive substrate. Additional layers can be used also, as described further below.

The organophotoreceptors can be incorporated into an electrophotographic imaging apparatus, such as laser printers. In these devices, an image is formed from physical embodiments and converted to a light image that is scanned onto the organophotoreceptor to form a surface latent image. The surface latent image can be used to attract toner onto the surface of the organophotoreceptor, in which the toner image is the same or the negative of the light image projected onto the organophotoreceptor. The toner can be a liquid toner or a dry toner. The toner is subsequently transferred, from the surface of the organophotoreceptor, to a receiving surface, such as a sheet of paper. After the transfer of the toner, the entire surface is discharged, and the material is ready to cycle again. The imaging apparatus can further comprise, for example, a plurality of support rollers for transporting a paper receiving medium and/or for movement of the photoreceptor, a light imaging component with suitable optics to form the light image, a light source, such as a laser, a toner source and delivery system and an appropriate control system.

An electrophotographic imaging process generally can comprise (a) applying an electrical charge to a surface of the above-described organophotoreceptor; (b) imagewise exposing the surface of the organophotoreceptor to radiation to dissipate charge in selected areas and thereby form a pattern of charged and uncharged areas on the surface; (c) exposing the surface with a toner, such as a liquid toner that includes a dispersion of colorant particles in an organic liquid to create a toner image, to attract toner to the charged or discharged regions of the organophotoreceptor; and (d) transferring the toner image to a substrate.

In describing chemicals by structural formulae and group definitions, certain terms are used in a nomenclature format that is chemically acceptable. The terms groups, moiety, and derivatives have particular meanings. The term group indicates that the generically recited chemical material (e.g., alkyl group, phenyl group, fluorenylidene malonitrile group, carbazole hydrazone group, etc.) may have any substituent thereon which is consistent with the bond structure of that group. For example, alkyl group includes alkyl materials such as methyl ethyl, propyl iso-octyl, dodecyl and the like, and also includes such substituted alkyls such as chloromethyl, dibromoethyl, 1,3-dicyanopropyl, 1,3,5-trihydroxyhexyl, 1,3,5-trifluorocyclohexyl, 1-methoxy-dodecyl, phenylpropyl and the like. However, as is consistent with such nomenclature, no substitution would be included within the term that would alter the fundamental bond structure of the underlying group. For example, where a phenyl ring group is recited, substitution such as 1-hydroxyphenyl, 2,4-fluorophenyl, orthocyanophenyl, 1,3,5-trimethoxyphenyl and the like would be acceptable within the terminology, while substitution of 1,1,2,2,3,3-hexamethylphenyl would not be acceptable as that substitution would require the ring bond structure of the phenyl group to be altered to a non-aromatic form because of the substitution. Where the term moiety is used, such as alkyl moiety or phenyl moiety, that terminology indicates that the chemical material is not substituted. Where the term derivative is used, that terminology indicates that a compound is derived or obtained from another and containing essential elements of the parent substance.

Organophotoreceptors

The organophotoreceptor may be, for example, in the form of a plate, a flexible belt, a disk, a rigid drum, or a sheet around a rigid or compliant drum, with flexible belts and rigid drums generally being used in commercial embodiments. The organophotoreceptor may comprise, for example, an electrically conductive substrate and a photoconductive element in the form of one or more layers. The organophotoreceptor generally comprises both a charge transport compound and a charge generating compound in a polymeric binder, which may or may not be in the same layer. Similarly, the electron transport compound may or may not be in the same layer with the charge generating compound. If the electron transport compound is in a different layer from the charge generating compound, the electron transport compound can be an overcoat, i.e., on the side opposite the electrically conductive substrate, or an undercoat, on the same side of the charge generating layer as the electrically conductive substrate. Generally, a layer with the electron transport compound further includes an ultraviolet light stabilizer.

With respect to the charge generation compound and the charge transport compound, in some embodiments with a single layer construction, the charge transport compound and the charge generating compound are in a single layer. In other embodiments, however, the photoconductive element comprises a bilayer construction featuring a charge generating layer and a separate charge transport layer. The charge generating layer may be located intermediate between the electrically conductive substrate and the charge transport layer. Alternatively, the photoconductive element may have a structure in which the charge transport layer is intermediate between the electrically conductive substrate and the charge generating layer.

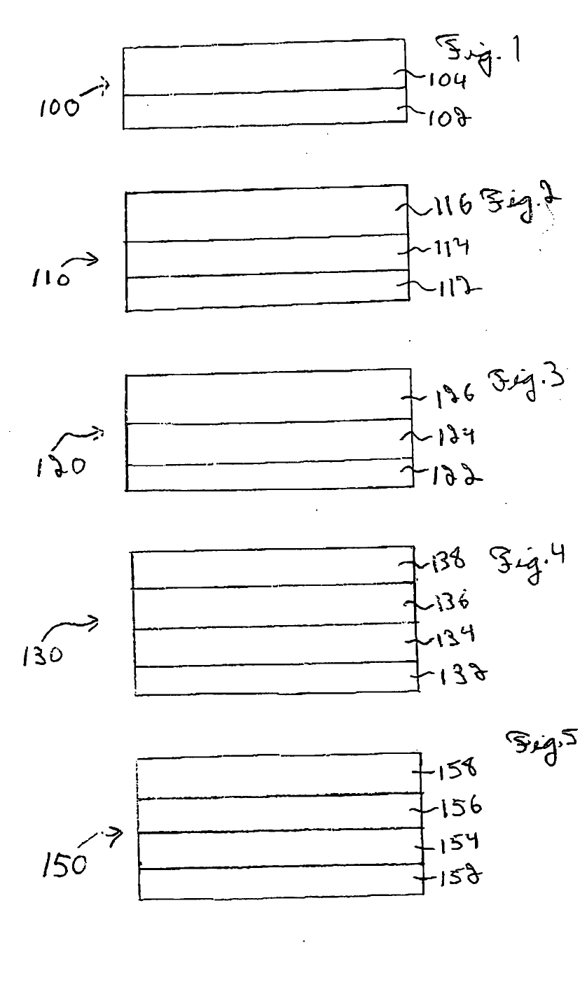

Based on the three basic structures of the charge generating layer and the charge transport layer, the structure of the organophotoreceptor can be generalized to account for the presence of an electron transport compound. For example, for embodiments in which the electron transport compound is in the same layer as the charge generating compound, there are three possible structures shown schematically in FIGS. 1-3. Referring to FIG. 1, organophotoreceptor 100 comprises an electrically conductive substrate 102 and a photoconductive layer 104 comprising a charge generating compound, a charge transport compound, an electron transport compound and a UV light stabilizer. Referring to FIG. 2, organophotoreceptor 110 comprises an electrically conductive substrate 112, a charge generating layer 114 comprising a charge generating compound, an electron transport compound and a UV stabilizing compound, and charge transport layer 116 comprising a charge transport compound. Referring to FIG. 3, organophotoreceptor 120 comprises an electrically conductive substrate 122, a charge transport layer 124 comprising a charge transport compound and a charge generating layer 126 comprising a charge generating compound, an electron transport compound and a UV stabilizing compound.

For embodiments in which the electron transport compound is in a different layer than the charge generating compound, there are two structures of primary interest, which are shown in FIGS. 4 and 5. Referring to FIG. 4, organophotoreceptor 130 comprises an electrically conductive substrate 132, a charge transport layer 134 comprising a charge transport compound, a charge generating layer 136 comprising a charge generating compound, and an electron transport layer 138 comprising an electron transport compound and a UV stabilizing compound. Referring to FIG. 5, organophotoreceptor 150 comprises an electrically conductive substrate 152, an electron transport layer 154 comprising an electron transport compound and a UV stabilizing compound, a charge generating layer 156 comprising a charge generating compound, and a charge transport layer 158 comprising a charge transport compound.

While the embodiments of FIGS. 1-5 have electron transport compound in a single layer, multiple layers can comprise an electron transport compound. In particular, an electron transport layer and a charge generating layer can both comprises an electron transport compound. Furthermore, the organophotoreceptor structures shown in FIGS. 1-5 can further comprise additional undercoat and/or overcoat layers such as those described further below. In addition, other layered organophotoreceptor structures can be formed beyond the embodiments of particular interest shown in FIGS. 1-5, and these additional structures can have different layer ordering and/or multiple layers of the types described with or without different compositions.

The electrically conductive substrate, along with electrically insulating substrate 108, may be flexible, for example in the form of a flexible web or a belt, or inflexible, for example in the form of a drum. A drum can have a hollow cylindrical structure that provides for attachment of the drum to a drive that rotates the drum during the imaging process. Typically, the combined substrate comprises an electrically insulating substrate and a thin layer of electrically conductive material as the electrically conductive substrate onto which the photoconductive material is applied.

The electrically insulating substrate may be paper or a film forming polymer such as polyethylene terephthalate, polyimide, polysulfone, polyethylene naphthalate, polypropylene, nylon, polyester, polycarbonate, polyvinyl fluoride, polystyrene, mixtures thereof and the like. Specific examples of polymers for supporting substrates include, for example, polyethersulfone (STABAR™ S-100, available from ICI), polyvinyl fluoride (TEDLAR®, available from E.I. DuPont de Nemours & Company), polybisphenol-A polycarbonate (MAKROFOL™, available from Mobay Chemical Company) and amorphous polyethylene terephthalate (MELINAR™, available from ICI Americas, Inc.). The electrically conductive materials may comprise graphite, dispersed carbon black, iodide, conductive polymers such as polypyroles and CALGON™ conductive polymer 261 (commercially available from Calgon Corporation, Inc., Pittsburgh, Pa.), metals such as aluminum, titanium, chromium, brass, gold, copper, palladium, nickel, or stainless steel, a metal oxide such as tin oxide or indium oxide, or combinations thereof. In embodiments of particular interest, the electrically conductive material is aluminum. Generally, the photoconductor substrate has a thickness adequate to provide the required mechanical stability. For example, flexible web substrates generally have a thickness from about 0.01 to about 1 mm, while drum substrates generally have a thickness from about 0.5 mm to about 2 mm.

The charge generating compound is a material, such as a dye or pigment, which is capable of absorbing light to generate charge carriers. Examples of suitable charge generating compounds include metal-free phthalocyanines (e.g., CGM-X01 available from Sanyo Color Works, Ltd.), metal phthalocyanines such as titanium phthalocyanine, copper phthalocyanine, oxytitanium phthalocyanine, hydroxygallium phthalocyanine, squarylium dyes and pigments, hydroxy-substituted squarylium pigments, perylimides, polynuclear quinones available from Allied Chemical Corporation under the trade name INDOFAST® Double Scarlet, INDOFAST® Violet Lake B, INDOFAST® Brilliant Scarlet and INDOFAST® Orange, quinacridones available from DuPont under the trade name MONASTRAL™ Red, MONASTRAL™ Violet and MONASTRAL™ Red Y, naphthalene 1,4,5,8-tetracarboxylic acid derived pigments including the perinones, tetrabenzoporphyrins and tetranaphthaloporphyrins, indigo- and thioindigo dyes, benzothioxanthene-derivatives, perylene 3,4,9,10-tetracarboxylic acid derived pigments, polyazo-pigments including bisazo-, trisazo- and tetrakisazo-pigments, polymethine dyes, dyes containing quinazoline groups, tertiary amines, amorphous selenium, selenium alloys such as selenium-tellurium, selenium-tellurium-arsenic and selenium-arsenic, cadmium sulphoselenide, cadmium selenide, cadmium sulphide, and mixtures thereof. For some embodiments, the charge generating compound comprises oxytitanium phthalocyanine, hydroxygallium phthalocyanine or a combination thereof.

Any suitable electron transport composition may be used in the appropriate layer or layers. Generally, the electron transport composition has an electron affinity that is large relative to potential electron traps while yielding an appropriate electron mobility in a composite with a polymer. In some embodiments, the electron transport composition has a reduction potential less than O₂. In general, electron transport compositions are easy to reduce and difficult to oxidize while charge transport compositions generally are easy to oxidize and difficult to reduce. In some embodiments, the electron transport compounds have a room temperature, zero field electron mobility of at least about 1×10⁻¹³ cm²/Vs, in further embodiments at least about 1×10⁻¹⁰ cm²/Vs, in additional embodiments at least about 1×10⁻⁸ cm²/Vs, and in other embodiments at least about 1×10⁻⁶ cm²/Vs. A person of ordinary skill in the art will recognize that other ranges of electron mobility within the explicit ranges are contemplated and are within the present disclosure.

Non-limiting examples of suitable electron transport compound include bromoaniline, tetracyanoethylene, tetracyanoquinodimethane, 2,4,7-trinitro-9-fluorenone, 2,4,5,7-tetranitro-9-fluorenone, 2,4,5,7-tetranitroxanthone, 2,4,8-trinitrothioxanthone, 2,6,8-trinitro-4H-indeno[1,2-b]thiophene-4-one, and 1,3,7-trinitrodibenzothiophene-5,5-dioxide, (2,3-diphenyl-1-indenylidene)malononitrile, 4H-thiopyran-1,1-dioxide and its derivatives, such as 4-dicyanomethylene-2,6-diphenyl-4H-thiopyran-1,1-dioxide, 4-dicyanomethylene-2,6-di-m-tolyl-4H-thiopyran-1,1-dioxide, and unsymmetrically substituted 2,6-diaryl-4H-thiopyran-1,1-dioxide such as 4H-1,1-dioxo-2-(p-isopropyl phenyl)-6-phenyl-4-(dicyanomethylidene)thiopyran and 4H-1,1-dioxo-2-(p-isopropyl phenyl)-6-(2-thienyl)-4-(dicyanomethyl-idene)thiopyran, derivatives of phospha-2,5-cyclohexadiene, (alkoxycarbonyl-9-fluorenylidene)malononitrile derivatives such as (4-n-butoxycarbonyl-9-fluorenylidene)malononitrile, (4-phenethoxycarbonyl-9-fluorenylidene) malononitrile, (4-carbitoxy-9-fluorenylidene)malononitrile, and diethyl(4-n-butoxy carbonyl-2,7-dinitro-9-fluorenylidene)-malonate, anthraquino dimethane derivatives such as 11,11,12,12-tetracyano-2-alkylanthraquinodimethane and 11,11-dicyano-12,12-bis(ethoxycarbonyl)anthraquinodimethane, anthrone derivatives such as 1-chloro-10-[bis(ethoxycarbonyl) methylene] anthrone, 1,8-dichloro-10-[bis(ethoxycarbonyl) methylene]anthrone, 1,8-dihydroxy-10-[bis(ethoxycarbonyl) methylene]anthrone, and 1-cyano-10-[bis(ethoxycarbonyl) methylene) anthrone, 7-nitro-2-aza-9-fluroenylidene-malononitrile, diphenoquinone derivatives, benzoquinone derivatives, naphtoquinone derivatives, quinine derivatives, tetracyanoethylenecyanoethylene, 2,4,8-trinitro thioxantone, dinitrobenzene derivatives, dinitroanthracene derivatives, dinitroacridine derivatives, nitroanthraquinone derivatives, dinitroanthraquinone derivatives, succinic anhydride, maleic anhydride, dibromo maleic anhydride, pyrene derivatives, carbazole derivatives, hydrazone derivatives, N,N-dialkylaniline derivatives, diphenylamine derivatives, triphenylamine derivatives, triphenylmethane derivatives, tetracyanoquinone dimethane, 2,4,5,7-tetranitro-9-fluorenone, 2,4,7-trinitro-9-dicyanomethylenene fluorenone, 2,4,5,7-tetranitroxanthone derivatives, 2,4,8-trinitrothioxanthone derivatives and combinations thereof.

Ultraviolet light stabilizers can be ultraviolet light absorbers or ultraviolet light inhibitors. UV light absorbers can absorb ultraviolet radiation and dissipate it as heat. UV light inhibitors are thought to trap free radicals generated by the ultraviolet light and after trapping of the free radicals, subsequently to regenerate active stabilizer moieties with energy dissipation. It has been discovered that UV stabilizers have a synergistic relationship with electron transport compounds to conduct electrons along the pathway established by the electric field in an organophotoreceptor during use. Thus, the particular advantages of the UV stabilizers are not their UV stabilizing abilities, although the UV stabilizing ability may be further advantageous in reducing degradation of the organophotoreceptor over time. While not wanting to be limited by theory, the synergistic relationship contributed by the UV stabilizers may be related to the electronic properties of the compounds, which contribute to the UV stabilizing function, further contribute to establishing electron conduction pathways in combination with the electron transport compounds. In particular, the improved organophotoreceptors demonstrate a reduced decrease of acceptance voltage V_{acc} after cycling, as described further below.

Non-limiting examples of suitable light stablizer include hindered trialkylamines such as TINUVIN™ 144 and TINUVIN™ 292 (from Ciba Specialty Chemicals, Terrytown, N.Y.), hindered alkoxydialkylamines such as TINUVIN™ 123 (from Ciba Specialty Chemicals), benzotriazoles such as TINUVAN™ 328, TINUVIN™ 900 and TINUVIN™ 928 (from Ciba Specialty Chemicals), benzophenones such as SANDUVOR™ 3041 (from Clariant Corp., Charlotte, N.C.), nickel compounds such as ARBESTAB™ (from Robinson Brothers Ltd, West Midlands, Great Britain), salicylates, cyanocinnamates, benzylidene malonates, benzoates, oxanilides such as SANDUVOR™ VSU (from Clariant Corp., Charlotte, N.C.), triazines such as CYAGARD™ UV-1164 (from Cytec Industries Inc., N.J.), polymeric sterically hindered amines such as LUCHEM™ (from atochem North America, Buffalo, N.Y.). Preferably, the light stabilizer is selected from the group consisting of hindered trialkylamines having the following formulae: 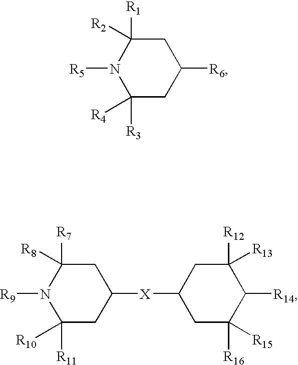
where R₁, R₂, R₃, R₄, R₆, R₇, R₈, R₁₀, R₁₁, R₁₂, R₁₃, R₁₄, R₁₅ are, independently, hydrogen, alkyl group, or ester, or ether group; and R₅, R₉, and R₁₄ are, independently, alkyl group; and X is a linking group selected from the group consisting of —O—CO—(CH₂)ₘ—CO—O— where m is between 2 to 20.

There are many kinds of charge transport compounds available for electrophotography. For example, any charge transport compound known in the art can be used to form organophotoconductors described herein. Suitable charge transport compounds include, but are not limited to, pyrazoline derivatives, fluorene derivatives, oxadiazole derivatives, stilbene derivatives, hydrazone derivatives, carbazole hydrazone derivatives, triaryl amines, polyvinyl carbazole, polyvinyl pyrene, polyacenaphthylene, or multi-hydrazone compounds comprising at least two hydrazone groups and at least two groups selected from the group consisting of triphenylamine and heterocycles such as carbazole, julolidine, phenothiazine, phenazine, phenoxazine, phenoxathiin, thiazole, oxazole, isoxazole, dibenzo(1,4)dioxine, thianthrene, imidazole, benzothiazole, benzotriazole, benzoxazole, benzimidazole, quinoline, isoquinoline, quinoxaline, indole, indazole, pyrrole, purine, pyridine, pyridazine, pyrimidine, pyrazine, triazole, oxadiazole, tetrazole, thiadiazole, benzisoxazole, benzisothiazole, dibenzofuran, dibenzothiophene, thiophene, thianaphthene, quinazoline, cinnoline or combinations thereof. In some embodiments, the charge transport compound is an enamine stilbene compound such as MPCT-10, MPCT-38, and MPCT-46 from Mitsubishi Paper Mills (Tokyo, Japan).

The polymer binder for any of the particular layers of the organophotoreceptor generally is capable of dispersing or dissolving the corresponding functional compounds, such as the electron transport composition, the charge transport compound, the charge generating compound and the UV light stabilizing compound. Examples of suitable polymer binders generally include, for example, polystyrene-co-butadiene, polystyrene-co-acrylonitrile, modified acrylic polymers, polyvinyl acetate, styrene-alkyd resins, soya-alkyl resins, polyvinylchloride, polyvinylidene chloride, polyacrylonitrile, polycarbonates, polyacrylic acid, polyacrylates, polymethacrylates, styrene polymers, polyvinyl butyral, alkyd resins, polyamides, polyurethanes, polyesters, polysulfones, polyethers, polyketones, phenoxy resins, epoxy resins, silicone resins, polysiloxanes, poly(hydroxyether) resins, polyhydroxystyrene resins, novolak, poly(phenylglycidyl ether)-co-dicyclopentadiene, copolymers of monomers used in the above-mentioned polymers, and combinations thereof. In some embodiments of particular interest, the binder is selected from the group consisting of polycarbonates, polyvinyl butyral, and a combination thereof. Examples of suitable polycarbonate binders include polycarbonate A which is derived from bisphenol-A, polycarbonate Z, which is derived from cyclohexylidene bisphenol, polycarbonate C, which is derived from methylbisphenol A, and polyestercarbonates. Examples of suitable of polyvinyl butyral are BX-1 and BX-5 form Sekisui Chemical Co. Ltd., Japan. For a release layer, it may be desirable for the polymer to be, for example, a fluorinated polymer, siloxane polymer, fluorosilicone polymer, polysilane, polyethylene, polypropylene, polyacrylate, poly(methyl methacrylate-co-methacrylic acid), urethane resins, urethane-epoxy resins, acrylated-urethane resins, urethane-acrylic resins, crosslinked polymers thereof or a combination thereof.

Suitable optional additives for any one or more of the layers include, for example, antioxidants, coupling agents, dispersing agents, curing agents, surfactants and combinations thereof.

The photoconductive element overall typically has a thickness of from about 10 to about 45 microns. In the dual layer embodiments having a separate charge generating layer and a separate charge transport layer, charge generation layer generally has a thickness form about 0.5 to about 2 microns, and the charge transport layer has a thickness from about 5 to about 35 microns. In embodiments in which the charge transport compound and the charge generating compound are in the same layer, the layer with the charge generating compound and the charge transport composition generally has a thickness from about 7 to about 30 microns. In embodiments with an electron transport layer, the electron transport layer has an average thickness from about 0.5 microns to about 10 microns and in further embodiments from about 1 micron to about 3 microns. The electron transport layer generally increases mechanical abrasion resistance, increases resistance to carrier liquid and atmospheric moisture, and decreases degradation of the photoreceptor by corona gasses. A person of ordinary skill in the art will recognize that additional ranges of thickness within the explicit ranges above are contemplated and are within the present disclosure.

For the dual layer embodiments with a separate charge generating layer and a charge transport layer, charge generation layer 110 generally comprises a binder in an amount from about 10 to about 90 weight percent and in some embodiments in an amount of from about 20 to about 75 weight percent, based on the weight of the charge generation layer. The optional electron transport compound in the charge generating layer, if present, generally can be in an amount of at least about 2.5 weight percent, in further embodiments from about 4 to about 30 weight percent and in other embodiments in an amount from about 10 to about 25 weight percent, based on the weight of the charge generating layer. The charge transport layer generally comprises a binder in an amount from about 30 weight percent to about 70 weight percent. A person of ordinary skill in the art will recognize that additional ranges of binder concentrations for the dual layer embodiments within the explicit ranges above are contemplated and are within the present disclosure.

For the embodiments with a single layer having a charge generating compound and a charge transport compound, the photoconductive layer generally comprises a binder, a charge transport compound and a charge generation compound. The charge generation compound can be in an amount of from about 0.05 to about 25 weight percent and in further embodiment in an amount of from about 2 to about 15 weight percent, based on the weight of the photoconductive layer. The charge transport compound can be in an amount from about 15 to about 80 weight percent, in other embodiments from about 25 to about 65 weight percent and in further embodiments in an amount of from about 30 to about 55 weight percent, based on the weight of the photoconductive layer, with the remainder of the photoconductive layer comprising the binder, and optionally additives, such as any conventional additives. A single layer with a charge transport composition and a charge generating compound generally comprises a binder in an amount from about 10 weight percent to about 75 weight percent, and in further embodiments from about 25 weight percent to about 60 weight percent. Optionally, the layer with the charge generating compound and the charge transport compound may comprise an electron transport compound. The optional electron transport compound, if present, generally can be in an amount of at least about 2.5 weight percent, in further embodiments from about 4 to about 30 weight percent and in other embodiments in an amount from about 10 to about 25 weight percent, based on the weight of the photoconductive layer. A person of ordinary skill in the art will recognize that additional compositions ranges within the explicit compositions ranges for the layers above are contemplated and are within the present disclosure. A person of ordinary skill in the art will recognize that additional ranges of binder concentrations are contemplated and are within the present disclosure.

The electron transport layer generally can comprise an electron transport compound, a UV light stabilizer and a binder. An overcoat layer comprising an electron transport compound is described further in copending U.S. patent application Ser. No. 10/396,536 to Zhu et al. entitled, “Organoreceptor With An Electron Transport Layer,” incorporated herein by reference. For example, an electron transport compound as described above may be used in the release layer of this invention. The electron transport compound in an electron transport layer can be in an amount from about 10 to about 50 weight percent, and in other embodiments in an amount from about 20 to about 40 weight percent, based on the weight of the electron transport layer. A person of ordinary skill in the art will recognize that additional ranges of compositions within the explicit ranges are contemplated and are within the present disclosure.

The UV light stabilizer in each of one or more appropriate layers of the photoconductor generally is in an amount from about 0.5 to about 25 weight percent and in some embodiments in an amount from about 1 to about 10 weight percent, based on the weight of the particular layer.

The photoconductive element may be formed in accordance with any appropriate technique known in the art, such as dip coating, spray coating, extrusion and the like. A person of ordinary skill in the art will recognize that additional ranges of compositions and thickness within the explicit ranges are contemplated and are within the present disclosure.

The photoreceptor may optionally have additional layers as well. Such additional layers can be, for example, a sub-layer and/or an additional overcoat layer. The sub-layer can be a charge blocking layer and locates between the electrically conductive substrate and the photoconductive element. The sub-layer may also improve the adhesion between the electrically conductive substrate and the photoconductive element.

Overcoat layers can be, for example, barrier layers, release layers, protective layers, and adhesive layers. With respect to overcoat layers, the photoreceptor can comprise a plurality of overcoat layers having an electron transport composition. For example, the release layer or the protective layer may contain an electron transport compound. One or more of the electron transport compounds described above may be used in the release layer or the protective layer.

The electron transport compound in the release layer or the protective layer generally can be in an amount of from about 2 to about 50 weight percent and in further embodiments in an amount of from about 10 to about 40 weight percent, based on the weight of the release layer or the protective layer. A person of ordinary skill in the art will recognize that additional ranges of composition within the explicit ranges are contemplated and are within the present disclosure. While an overcoat layer may or may not have an electron transport composition, the presence of an electron transport composition in each overcoat layer (which may or may not be the same composition as in other overcoat layers) can provide continuity of electrical conductivity between a charge generating layer and the surface, which may improve the performance of the organophotoreceptor.

The release layer or the protective layer forms the uppermost layer of the photoconductor layer. A release layer is a top layer that facilitates the transfer of toner from the organophotoreceptor to an intermediate transfer medium, such as a belt or drum, or to a receiving medium, such as paper, when the toner transfer is not facilitated by electrostatic forces or magnetic forces. A release layer can have a lower surface energy than the surface energy of the medium to which the toner is transferred from the organophotoreceptor. The barrier layer may be sandwiched between the release layer and the photoconductive element or used to overcoat the photoconductive element. The barrier layer provides protection for abrasion and solvent resistance to the underlayers. A protective layer is a top layer that provides protection for abrasion and solvent resistance to the underlayers. A layer can be both a protective layer and a release layer. An adhesive layer locates and improves the adhesion between a charge generating layer and an overcoat layer or between two overcoat layers.

Suitable barrier layers include, for example, coatings such as crosslinkable siloxanol-colloidal silica coating and hydroxylated silsesquioxane-colloidal silica coating, and organic binders such as polyvinyl alcohol, methyl vinyl ether/maleic anhydride copolymer, casein, polyvinyl pyrrolidone, polyacrylic acid, gelatin, starch, polyurethanes, polyimides, polyesters, polyamides, polyvinyl acetate, polyvinyl chloride, polyvinylidene chloride, polycarbonates, polyvinyl butyral, polyvinyl acetoacetal, polyvinyl formal, polyacrylonitrile, polymethyl methacrylate, polyacrylates, polyvinyl carbazoles, copolymers of monomers used in the above-mentioned polymers, vinyl chloride/vinyl acetate/vinyl alcohol terpolymers, vinyl chloride/vinyl acetate/maleic acid terpolymers, ethylene/vinyl acetate copolymers, vinyl chloride/vinylidene chloride copolymers, cellulose polymers, and mixtures thereof. The above barrier layer polymers optionally may contain small inorganic particles such as fumed silica, silica, titania, alumina, zirconia, or a combination thereof. Barrier layers are described further in U.S. Pat. No. 6,001,522 to Woo et al., entitled Barrier Layer For Photoconductor Elements Comprising An Organic Polymer And Silica,” incorporated herein by reference.

The release layer topcoat may comprise, for example, any release layer composition known in the art. In some embodiments, the release layer is a fluorinated polymer, siloxane polymer, fluorosilicone polymer, polysilane, polyethylene, polypropylene, polyacrylate, poly(methyl methacrylate-co-methacrylic acid), urethane resins, urethane-epoxy resins, acrylated-urethane resins, urethane-acrylic resins, or a combination thereof. The release layers can comprise crosslinked polymers.

The protective layer protects the organophotoreceptor from chemical and mechanical degradation. The protective layer may comprise, for example, any protective layer composition known in the art. Preferably, the protective layer is a fluorinated polymer, siloxane polymer, fluorosilicone polymer, silane, polyethylene, polypropylene, polyacrylate, poly(methyl methacrylate-co-methacrylic acid), urethane resins, urethane-epoxy resins, acrylated-urethane resins, urethane-acrylic resins, or a combination thereof. In some embodiments, the protective layer comprises crosslinked polymers.

Generally, adhesive layers comprise a film forming polymer, such as polyester, polyvinylbutyral, polyvinylpyrolidone, polyurethane, polymethyl methacrylate, poly(hydroxy amino ether) and the like. Overcoat layers are described further in U.S. Pat. No. 6,180,305 to Ackley et al., entitled “Organic Photoreceptors For Liquid Electrophotography,” incorporated herein by reference.

Sub-layers can comprise, for example, polyvinylbutyral, organosilanes, hydrolyzable silanes, epoxy resins, polyesters, polyamides, polyurethanes, silicones and the like. In some embodiments, the sub-layer has a dry thickness between about 20 Angstroms and about 2,000 Angstroms. Sublayers containing metal oxide conductive particles can be 1-25 microns thick. A person of ordinary skill in the art will recognize that additional ranges of compositions and thickness within the explicit ranges are contemplated and are within the present disclosure.

The organophotoreceptors as described herein are suitable for use in an imaging process with either dry or liquid toner development including, for example, dry toners and liquid toners known in the art. Liquid toner development can be desirable because it offers the advantages of providing higher resolution images and requiring lower energy for image fixing compared to dry toners. Examples of suitable liquid toners are known in the art. Liquid toners generally comprise toner particles dispersed in a carrier liquid. The toner particles generally can comprise a colorant/pigment, a resin binder, and/or a charge director. In some embodiments of liquid toner, a resin to pigment ratio can be from 2:1 to 10:1, and in other embodiments, from 4:1 to 8:1. Liquid toners are described further in Published U.S. patent applications 2002/0128349, entitled “Liquid Inks Comprising A Stable Organosol,” 2002/0086916, entitled “Liquid Inks Comprising Treated Colorant Particles,” and 2002/0197552, entitled “Phase Change Developer For Liquid Electrophotography,” all three of which are incorporated herein by reference.

Performance Properties of the Organophotoreceptors With UV Stabilizers

The organophotoreceptors with a UV stabilizer and an electron transport compound in the same layer have synergistic improvement in the electrostatic testing properties of the organophotoreceptor. In particular, the acceptance voltage (V_{acc}) of the organophotoreceptor is observed to decay much less upon cycling of the organophotoreceptor over many cycles. This significant improvement in the cycling properties of the organophotoreceptor can provide significant commercial advantages.

Specifically, the improved organophotoreceptors can have a change in acceptance voltage following 1000 cycles, relative to the initial acceptance voltage, of less than about 20 percent, in some embodiments no more than about 15 percent, in additional embodiments no more than about 10 percent, in further embodiments no more than about 7 percent and in other embodiments no more than about 2 percent. In some embodiments, it has been possible to have an acceptance voltage that does not change within experimental measurement error after 1000 cycles. With respect to actual voltage values, the improved organophotoreceptors, following 1000 cycles, can have an acceptance voltage of at least about 430 volts, in some embodiments at least about 445 volts, in additional embodiments at least about 460 volts and in further embodiments from about 470 to about 580 volts. For the evaluation of these values, a cycle is performed by charging the surface with a corona charge, discharging a portion of the surface with a laser and discharging the entire surface with an erase lamp. A person of ordinary skill in the art will recognize that additional ranges of acceptance voltage following cycling and differences in acceptance voltage following cycling within the explicit ranges above are contemplated and are within the present disclosure.

Organophotoreceptor (OPR) Preparation Methods

Conveniently, the photoconductive element may be formed by dispersing or dissolving the components, such as a charge generating compound, a charge transport compound, a light stabilizer, an electron transport compound, and/or a polymeric binder in organic solvent, coating the dispersion and/or solution on the respective underlying layer and drying the coating. In some embodiments, the components can be dispersed by high shear homogenization, ball-milling, attritor milling, high energy bead (sand) milling or other size reduction processes or mixing means known in the art for effecting particle size reduction in forming a dispersion. The coatings can be applied, for example, using knife coating, extrusion, dip coating or other appropriate coating approaches, including those known in the art. In some embodiments, a plurality of layers are applied as sequential coatings. The layers can be dried prior to the application of a subsequent layer. Some specific examples are presented below.

The invention will now be described further by way of the following examples.

### EXAMPLES

### Example 1

### Synthesis of an Electron Transport Compound

This example describes the preparation of (4-n-butoxycarbonyl-9-fluorenylidene) malononitrile.

A 460 g quantity of concentrated sulfuric acid (4.7 moles, analytical grade, commercially obtained from Sigma-Aldrich, Milwaukee, Wis.) and 100 g of diphenic acid (0.41 mole, commercially obtained from Acros Fisher Scientific Company Inc., Hanover Park, Ill.) were added to a 1-liter 3-neck round bottom flask, equipped with a thermometer, mechanical stirrer and a reflux condenser. Using a heating mantle, the flask was heated to 135-145° C. for 12 minutes, and then cooled to room temperature. After cooling to room temperature, the solution was added to a 4-liter Erlenmeyer flask containing 3 liter of water. The mixture was stirred mechanically and was boiled gently for one hour. A yellow solid was filtered out hot, washed with hot water until the pH of the wash-water was neutral, and was air-dried overnight. The yellow solid was fluorenone-4-carboxylic acid. The yield was 75 g (80%). The product was then characterized. The melting point (m.p.) was found to be 223-224° C. A ¹H-NMR spectrum of fluorenone-4-carboxylic acid was obtained in d₆-DMSO solvent with a 300 MHz NMR from Bruker Instrument. The peaks were found at (ppm) δ=7.39-7.50 (m, 2H); ε=7.79-7.70 (q, 2H); δ=7.74-7.85 (d, 1H); δ=7.88-8.18-8.30 (d, 1H), where d is doublet, t is triplet, m is multiplet, dd is double doublet, q is quintet.

A 70 g (0.312 mole) quantity of fluorenone-4-carboxylic acid, 480 g (6.5 mole) of n-Butanol (commercially obtained from Fisher Scientific Company Inc., Hanover Park, Ill.), 1000 ml of Toluene and 4 ml of concentrated sulfuric acid were added to a 2-liter round bottom flask equipped with a mechanical stirrer and a reflux condenser with a Dean Stark apparatus. With aggressive agitation and refluxing, the solution was refluxed for 5 hours, during which ˜6 g of water were collected in the Dean Stark apparatus. The flask was cooled to room temperature. The solvents were evaporated and the residue was added, with agitation, to 4-liter of a 3% sodium bicarbonate aqueous solution. The solid was filtered off, washed with water until the pH of the wash-water was neutral, and dried in the hood overnight. The product was n-butyl fluorenone-4-carboxylate ester. The yield was 70 g (80%). A ¹H-NMR spectrum of n-butyl fluorenone-4-carboxylate ester was obtained in CDCl₃ with a 300 MHz NMR from Bruker Instrument. The peaks were found at (ppm) δ=0.87-1.09 (t, 3H); δ=1.42-1.70 (m, 2H); δ=1.75-1.88 (q, 2H); δ=4.26-4.64 (t, 2H); δ=7.29-7.45 (m, 2H); δ=7.46-7.58 (m, 1H); δ=7.60-7.68 (dd, 1H); δ=7.75-7.82 (dd, 1H); δ=7.90-8.00 (dd, 1H); δ=8.25-8.35 (dd, 1H).

A 70 g (0.25 mole) quantity of n-butyl fluorenone-4-carboxylate ester, 750 ml of absolute methanol, 37 g (0.55 mole) of malononitrile (commercially obtained from Sigma-Aldrich, Milwaukee, Wis.), 20 drops of piperidine (commercially obtained from Sigma-Aldrich, Milwaukee, Wis.) were added to a 2-liter, 3-neck round bottom flask equipped with a mechanical stirrer and a reflux condenser. The solution was refluxed for 8 hours, and the flask was cooled to room temperature. The orange crude product was filtered, washed twice with 70 ml of methanol and once with 150 ml of water, and dried overnight in a hood. This orange crude product was recrystalized from a mixture of 600 ml of acetone and 300 ml of methanol using activated charcoal. The flask was placed at 0° C. for 16 hours. The crystals were filtered and dried in a vacuum oven at 50° C. for 6 hours to obtain 60 g of pure (4-n-butoxycarbonyl-9-fluorenylidene) malononitrile. The melting point (m.p.) of the solid was found to be 99-100° C. A ¹H-NMR spectrum of (4-n-butoxycarbonyl-9-fluorenylidene) malononitrile was obtained in CDCl₃ with a 300 MHz NMR from Bruker Instrument. The peaks were found at (ppm) δ=0.74-1.16 (t, 3H); δ=1.38-1.72 (m, 2H); δ=1.70-1.90 (q, 2H); δ=4.29-4.55 (t, 2H); δ=7.31-7.43 (m, 2H); δ=7.45-7.58 (m, 1H); δ=7.81-7.91 (dd, 1H); δ=8.15-8.25 (dd, 1H); δ=8.42-8.52 (dd, 1H); δ=8.56-8.66 (dd, 1H).

### Example 2

### Preparation of Organophotoreceptors

This example presents results of performance parameters for five samples formed with UV light stabilizers combined with an electron transport compound in an organophotoreceptor along with two comparative samples.

Preparation of Comparative Sample A

Comparative Example A was a single layer organophotoreceptor having a 76.2 micron (3 mil) thick polyester substrate having a layer of vapor-coated aluminum (commercially obtained from CP Films, Martinsville, Va.). The coating solution for the single layer organophotoreceptor was prepared by pre-mixing 2.4 g of 20 weight % (4-n-butoxycarbonyl-9-fluorenylidene) malononitrile in tetrahydrofuran, 6.66 g of 25 weight % MPCT-10 (an enamine-stylbene based charge transfer material, commercially obtained from Mitsubishi Paper Mills, Tokyo, Japan) in tetrahydrofuran, 7.65 g of 12 weight % polyvinyl butyral resin (BX-1, commercially obtained from Sekisui Chemical Co. Ltd., Japan) in tetrahydrofuran. A 0.74 g quantity of a CGM mill-base containing 19 weight % of titanyl oxyphthalocyanine and a polyvinyl butyral resin (BX-5, commercially obtained from Sekisui Chemical Co. Ltd., Japan) at a weight ratio of 2.3:1 was then added to the above mixture. The CGM mill-base was obtained by milling 112.7 g of titanyl oxyphthalocyanine (commercially obtained from H.W. Sands Corp., Jupiter, Fla.) with 49 g of the polyvinyl butyral resin (BX-5) in 651 g of methyl ethyl ketone (MEK) on a horizontal sand mill (model LMC12 DCMS, commercially obtained from Netzsch Incorporated, Exton, Pa.) with 1-micron zirconium beads using recycle mode for 4 hours. After mixing on a mechanical shaker for 1 hour, the single layer coating solution was coated onto the substrate described above using a knife coater with a gap space of 94 micron followed by drying in an oven at 110° C. for 5 minutes.

Preparation of Samples 1-3

Samples 1-3 were prepared similarly to the Comparative Sample A except that a 0.53 g portion of the 12 weight % polyvinyl butyral resin solution was replaced respectively by 0.53 g of 12 weight % of TINUVIN™ 124 (sample 1), TINUVIN™ 292 (sample 2), or TINUVIN™ 928 (sample 3) (all are light stabilizers commercially obtained from Ciba Specialty Chemical Corp., Terrytown, N.Y.) in tetrahydrofuran.

Preparation of Comparative Sample B

Comparative Sample B was prepared in the same way as described for Comparative Sample-A, except that it was prepared and tested at the same time with Samples 4 and 5.

Preparation of Samples 4

Samples 4 was prepared similarly to the Comparative Sample A except that a 0.96 g portion of the 12 weight % polyvinyl butyral resin solution was replaced by 0.43 g of 12 weight % of TINUVIN™ 292 and 0.53 g of 12 weight % of TINUVIN™ 928 in tetrahydrofuran.

Preparation of Samples 5

Samples 5 was prepared similarly to the Comparative Sample A except that a 0.37 g portion of the 12 weight % polyvinyl butyral resin solution was replaced by 0.08 g of 12 weight % of TINUVIN™ 292 and 0.29 g of 12 weight % of TINUVIN™ 928 in tetrahydrofuran.

### Example 3

### Electrostatic Testing and Properties of Organophotoreceptors

This example provides results of electrostatic testing on the organophotoreceptor samples formed as described in Example 2.

Electrostatic cycling performance of organophotoreceptors described herein can be determined using in-house designed and developed test bed that is capable of testing, for example, the hand coated sample strips wrapped around a 160 mm drum. The results on these samples are indicative of results that would be obtained with other support structures, such as belts, drums and the like, for supporting the organophotoreceptors.

For testing using a 160 mm drum, three coated sample strips, each measuring 50 cm long by 8.8 cm wide, are fastened side-by-side and completely around an aluminum drum (50.3 cm circumference). In some embodiments, at least one of the strips is a comparative example that is precision web coated and used as an internal reference point. In this electrostatic cycling tester, the drum rotated at a rate of 8.13 cm/sec (3.2 ips), and the location of each station in the tester (distance and elapsed time per cycle) is given as shown in the following table:

TABLE 1
Electrostatic test stations around the 160 mm drum at 8.13 cm/sec.

| | | Total Distance, | Total Time, |
|---|---|---|---|
| Station | Degrees | cm | sec |
| Front erase bar edge | 0° | Initial, 0 cm | Initial, 0 s |
| Erase Bar | 0-7.2° | 0-1.0 | 0-0.12 |
| Scorotron Charger | 113.1-135.3° | 15.8-18.9 | 1.94-2.33 |
| Laser Strike | 161.0° | 22.5 | 2.77 |
| Probe #1 | 181.1° | 25.3 | 3.11 |
| Probe #2 | 251.2° | 35.1 | 4.32 |
| Erase bar | 360° | 50.3 | 6.19 |

The erase bar is an array of laser emitting diodes (LED) with a wavelength of 720 nm. that discharges the surface of the organophotoreceptor. The scorotron charger comprises a wire that permits the transfer of a desired amount of charge to the surface of the organophotoreceptor.

From the above table, the first electrostatic probe (TREK™ 344 electrostatic meter, Trek, Inc. Medina, N.Y.) is located 0.34 s after the laser strike station and 0.78 s after the scorotron while the second probe (TREK™ 344 electrostatic meter) is located 1.21 s from the first probe and 1.99 s from the scorotron. All measurements are performed at ambient temperature and relative humidity.

Electrostatic measurements were obtained as a compilation of several runs on a test station with the 160 mm drum. The first three diagnostic tests (prodtest initial, VlogE initial, dark decay initial) are designed to evaluate the electrostatic cycling of a new, fresh sample and the last three, identical diagnostic test (prodtest final, VlogE final, dark decay final) are run after cycling of the sample. In addition, measurements were made periodically during the test, as described under “longrun” below. The laser is operated at 780 nm wavelength, 600 dpi, 50 micron spot size, 60 nanoseconds/pixel expose time, 1,800 lines per second scan speed, and a 100% duty cycle. The duty cycle is the percent exposure of the pixel clock period, i.e., the laser is on for the full 60 nanoseconds per pixel at a 100% duty cycle.

Electrostatic Test Suite:

1) PRODTEST: Charge acceptance (V_{acc}) and discharge voltage (V_{dis}) were established by subjecting the samples to corona charging (erase bar always on) for three complete drum revolutions (laser off); discharged with the laser @ 780 nm & 600 dpi on the forth revolution (50 um spot size, expose 60 nanoseconds/pixel, run at a scan speed of 1,800 lines per second, and use a 100% duty cycle); completely charged for the next three revolutions (laser off); discharged with only the erase lamp @ 720 nm on the eighth revolution (corona and laser off) to obtain residual voltage (Vᵣₑₛ); and, finally, completely charged for the last three revolutions (laser off). The contrast voltage (V_{con}) is the difference between V_{acc} and V_{dis} and the functional dark decay (V_{dd}) is the difference in charge acceptance potential measured by probes #1 and #2.

2) VLOGE: This test measures the photoinduced discharge of the photoconductor to various laser intensity levels by monitoring the discharge voltage of the sample as a function of the laser power (exposure duration of 50 ns) with fixed exposure times and constant initial potentials. This test measures the photoinduced discharge of the photoconductor to various laser intensity levels by monitoring the discharge voltage of the sample as a function of the laser power (exposure duration of 50 ns) with fixed exposure times and constant initial potentials. The functional photosensitivity, S_{780 nm}, and operational power settings can be determined from this diagnostic test.

3) DARK DECAY: This test measures the loss of charge acceptance in the dark with time without laser or erase illumination for 90 seconds and can be used as an indicator of i) the injection of residual holes from the charge generation layer to the charge transport layer, ii) the thermal liberation of trapped charges, and iii) the injection of charge from the surface or aluminum ground plane.

4) LONGRUN: The sample was electrostatically cycled for 100 to 1,000 drum revolutions according to the following sequence per each sample-drum revolution. The sample was charged by the corona, the laser was cycled on and off (80-100° sections) to discharge a portion of the sample and, finally, the erase lamp discharged the whole sample in preparation for the next cycle. The laser was cycled so that the first section of the sample was never exposed, the second section was always exposed, the third section was never exposed, and the final section was always exposed. This pattern was repeated for a total of 100 to 1,000 drum revolutions, and the data was recorded periodically, after every 5th cycle for the 100 cycle longrun or after every 50th cycle for the 1,000 cycle longrun.

5) After the LONGRUN test, the PRODTEST, VLOGE, DARK DECAY diagnostic tests were run again.

The following Tables shows the results from the prodtest initial and prodtest final diagnostic tests. The values for the charge acceptance voltage (Vacc, probe #1 average voltage obtained from the third cycle), discharge voltage (Vdis, probe #1 average voltage obtained from the fourth cycle) are reported for the initial and final cycles.

TABLE 2
Electrostatic Testing Results of Single Layer
Organophotorecptor after 1000 Cycles.

| Samples | Vacc-1 | Vdis-1 | Vacc-2 | Vdis-2 | ΔVacc | ΔVdis |
|---|---|---|---|---|---|---|
| Comparative | 579 | 25 | 408 | 26 | −171 | 1 |
| Sample A | | | | | | |
| Sample 1- | 562 | 33 | 472 | 32 | −90 | −1 |
| Test 1 | | | | | | |
| Sample 1- | 538 | 31 | 449 | 31 | −89 | 0 |
| Test 2 | | | | | | |
| Sample 2 | 587 | 30 | 565 | 31 | −22 | 1 |
| Sample 3 | 493 | 24 | 433 | 26 | −60 | 2 |

Notes:
1) Vacc-1 and Vdis-1 are charge acceptance and discharge voltage at the start of cycling.
2) Vacc-2 and Vdis-2 are charge acceptance and discharge voltage at the end of cycling.
3) ΔVacc and ΔVdis are changes of charge acceptance and discharge voltages after 1000 cycles.
4) Results listed in Table 2 for “Sample 1-Test 1” and “Sample 1-Test 2” were obtained by running two fresh pieces of Sample 1.

TABLE 3
Electrostatic Testing Results of Single Layer Organophotorecptor after 1000 Or
4000 Cycles.

| | 1000 Cycles | | | | | | 4000 Cycles | | | | | |
|---|---|---|---|---|---|---|---|---|---|---|---|---|
| | Vacc- | Vdis- | Vacc- | Vdis- | | | Vacc- | Vdis- | Vacc- | Vdis | | |
| Samples | 1 | 1 | 2 | 2 | ΔVacc | ΔVdis | 1 | 1 | 2 | 2 | ΔVacc | ΔVdis |
| Comparative | 584 | 31 | 468 | 27 | −116 | −4 | 581 | 29 | 170 | 19 | −411 | −10 |
| Sample B | | | | | | | | | | | | |
| Sample 4 | 602 | 29 | 606 | 29 | 4 | 0 | 601 | 31 | 571 | 34 | −30 | 3 |
| Sample 5 | 605 | 25 | 602 | 29 | −3 | 4 | 608 | 25 | 561 | 38 | −47 | 13 |

Notes:
1) Vacc-1 and Vdis-1 are charge acceptance and discharge voltage at the start of cycling.
2) Vacc-2 and Vdis-2 are charge acceptance and discharge voltage at the end of cycling.
3) ΔVacc and ΔVdis are changes of charge acceptance and discharge voltages after 1000 cycles or 4000 cycles, as noted.

The results in Tables 2 and 3 demonstrate that the improved photoreceptors described herein can have significantly reduced changes in acceptance voltage V_{acc} after cycling compared with comparative examples. In particular, samples 4 and 5 with mixtures of UV stabilizers have particularly small in magnitude values of ΔV_{acc}.

The embodiments above are intended to be illustrative and not limiting. Additional embodiments are within the claims. Although the present invention has been described with reference to particular embodiments, workers skilled in the art will recognize that changes may be made in form and detail without departing from the spirit and scope of the invention.

1. An electrophotographic imaging process comprising:
(a) applying an electrical charge to a surface of an organophotoreceptor comprising an electrically conductive substrate having a surface and a photoconductive element on the surface of the electrically conductive substrate wherein the photoconductive element comprises a single layer comprising a polymeric binder, a charge generating compound, a charge transport compound for transporting holes, an electron transport compound and a light stabilizer;
(b) imagewise exposing the surface of the organophotoreceptor to radiation to dissipate charge in selected areas and thereby form a pattern of charged and uncharged areas on the surface;
(c) contacting the surface with a toner to create a toned image; and
(d) transferring the toned image to a receiving substrate.

2. An electrophotographic imaging process according to claim 1 wherein the light stabilizer is selected from the group consisting of hindered trialkylamines, hindered alkoxydialkylamines, benzotriazoles, benzophenones, salicylates, cyanocinnamates, benzylidene malonates, benzoates, oxanilides, triazines, and polymeric sterically hindered amines.

3. An electrophotographic imaging process according to claim 1 wherein the light stabilizer has one of the following formulae: 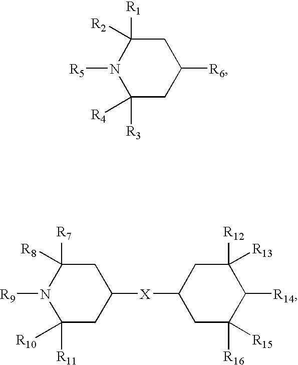
where R₁, R₂, R₃, R₄, R₆, R₇, R₈, R₁₀, R₁₁, R₁₂, R₁₃, R₁₄, R₁₅ are, independently, hydrogen, alkyl group, or ester, or ether group; and R₅, R₉, and R₁₄ are, independently, alkyl group; and X is a linking group selected from the group consisting of —O—CO—(CH₂)ₘ—CO—O— where m is between 2 to 20.

4. An electrophotographic imaging process according to claim 1 wherein the toner comprises a liquid toner comprising a dispersion of colorant particles in an organic liquid.

5. An electrophotographic imaging process according to claim 1 wherein the organophotoreceptor is in the form of a flexible belt or a drum.

6. An electrophotographic imaging process according to claim 1 wherein the first layer comprises from about 10 to about 25 weight percent electron transport compound.

7. An electrophotographic imaging process according to claim 1 wherein the first layer comprises from about 4 to about 30 weight percent electron transport compound.

8. An electrophotographic imaging process according to claim 1 wherein the first layer comprises from about 0.5 to about 25 weight percent UV light stabilizer.

9. An electrophotographic imaging process according to claim 1 wherein the charge transport compound is selected from the group consisting of pyrazoline derivatives, fluorene derivatives, oxadiazole derivatives, stilbene derivatives, hydrazone derivatives, carbazole hydrazone derivatives, triaryl amines, polyvinyl carbazole, polyvinyl pyrene, polyacenaphthylene, enamine stilbene compounds, and multi-hydrazone compounds comprising at least two hydrazone groups and at least two groups selected from the group consisting of triphenylamine and heterocycles.

10. An electrophotographic imaging process according to claim 9 wherein the charge transport compound is selected from the group consisting of enamine stilbene compounds and multi-hydrazone compounds comprising at least two hydrazone groups and at least two groups selected from the group consisting of triphenylamine and heterocycles.

11. An electrophotographic imaging process according to claim 9 wherein the heterocycles are selected from the group consisting of carbazole, julolidine, phenothiazine, phenazine, phenoxazine, phenoxathiin, thiazole, oxazole, isoxazole, dibenzo(1,4)dioxine, thianthrene, imidazole, benzothiazole, benzotriazole, benzoxazole, benzimidazole, quinoline, isoquinoline, quinoxaline, indole, indazole, pyrrole, purine, pyridine, pyridazine, pyrimidine, pyrazine, triazole, oxadiazole, tetrazole, thiadiazole, benzisoxazole, benzisothiazole, dibenzofuran, dibenzothiophene, thiophene, thianaphthene, quinazoline, and cinnoline.

12. An electrophotographic imaging process according to claim 1 wherein the electron transport compound is selected from the group consisting of bromoaniline, tetracyanoethylene, tetracyanoquinodimethane, 2,4,7-trinitro-9-fluorenone, 2,4,5,7-tetranitro-9-fluorenone, 2,4,5,7-tetranitroxanthone, 2,4,8-trinitrothioxanthone, 2,6,8-trinitro-4H-indeno[1,2-b]thiophene-4-one, 1,3,7-trinitrodibenzothiophene-5,5-dioxide, (2,3-diphenyl-1-indenylidene)malononitrile, 4H-thiopyran-1,1-dioxide and its derivatives, derivatives of phospha-2,5-cyclohexadiene, (alkoxycarbonyl-9-fluorenylidene)malononitrile derivatives, anthraquino dimethane derivatives, anthrone derivatives, 7-nitro-2-aza-9-fluroenylidene-malononitrile, diphenoquinone derivatives, benzoquinone derivatives, naphtoquinone derivatives, quinine derivatives, tetracyanoethylenecyanoethylene, 2,4,8-trinitro thioxantone, dinitrobenzene derivatives, dinitroanthracene derivatives, dinitroacridine derivatives, nitroanthraquinone derivatives, dinitroanthraquinone derivatives, succinic anhydride, maleic anhydride, dibromo maleic anhydride, tetracyanoquinone dimethane, 2,4,5,7-tetranitro-9-fluorenone, 2,4,7-trinitro-9-dicyanomethylenene fluorenone, 2,4,5,7-tetranitroxanthone derivatives, and 2,4,8-trinitrothioxanthone derivatives.

13. An electrophotographic imaging process according to claim 12 wherein the electron transport compound comprises an (alkoxycarbonyl-9-fluorenylidene)malononitrile derivative.

14. An electrophotographic imaging process according to claim 1 wherein the charge generating compound is selected from the group consisting of metal-free phthalocyanines, metal phthalocyanines, squarylium dyes and pigments, hydroxy-substituted squarylium pigments, perylimides, polynuclear quinones, quinacridones, naphthalene 1,4,5,8-tetracarboxylic acid derived pigments, indigo- and thioindigo dyes, benzothioxanthene-derivatives, perylene 3,4,9,10-tetracarboxylic acid derived pigments, polyazo-pigments, polymethine dyes, dyes containing quinazoline groups, amorphous selenium, and selenium alloys.

15. An electrophotographic imaging process according to claim 1 wherein the charge generating compound comprises a metal phthalocyanine.

16. An electrophotographic imaging process according to claim 15 wherein the metal phthalocyanine is selected from the group consisting of oxytitanium phthalocyanine and hydroxygallium phthalocyanine.
